(19) United States
(12) Patent Application Publication
(10) Pub. No.: US 2026/0202348 A1
(43) Pub. Date: Jul. 16, 2026

(54) TEST DEVICE

(71) Applicant: INTRAVIS GESELLSCHAFT FÜR LIEFERUNGEN UND LEISTUNGEN VON BILDGEBENDEN UND BILDVERARBEITENDEN ANLAGEN, Aachen (DE)

(72) Inventors: Gerd FUHRMANN, Aachen (DE); Michael RICK, Aachen (DE)

(21) Appl. No.: 19/133,836

(22) PCT Filed: Nov. 27, 2023
(86) PCT No.: PCT/EP2023/083153

§ 371 Date: May 29, 2025

(30) Foreign Application Priority Data
Jan. 18, 2023 (DE) 10 2023 101 162.6

(51) Int. Cl. G01N 21/90; G01N 21/88

(52) U.S. Cl. CPC G01N 21/9081; G01N 21/8806; G01N 21/9009; G01N 2021/8838

(57) ABSTRACT

A device for optically checking objects in the form of preforms includes an inclined plate and the objects to be checked move from a top edge to a bottom edge of the inclined plate. The viewing angles of a plurality of image-recording units capture an entire width of the plate and synchronously record multiple respective digital images of the objects moving on the plate. Ejections fingers that can be individually pivoted by respective drives are arranged in parallel next to one another along the lower edge of the inclined plate. A processing unit is configured to identify all objects fully displayed in the images, check each identified object for at least one feature, track the object, and calculate at what time in and what rotational position each identified object reaches a position in the region of the ejection fingers. Depending on the calculation and the result of the test, the drive of at least one ejection finger is actuated to eject the identified object.

The invention relates to a device for optically checking features of elongate, rotationally symmetrical objects, comprising a sloping plate with an upper and a lower edge, wherein the slope is determined in such a way that the objects to be checked move on the plate from the upper to the lower edge owing to the gravitational force acting on them.

The objects to be checked are, in particular, preforms from which containers, e.g. bottles, will be produced by blow molding. In order if possible to segregate defective preforms before the blow molding process, use is made of camera-based devices for optical checking, also referred to as inspection systems, which allow thorough checking of preforms.

Typical faults in preforms include hazing, contamination, inclusions, unmelted areas, bubbles, burn marks, incorrect colors, incorrect dimensions and/or shapes and incorrect gating points.

EP 2 976 204 B1 has already disclosed a method and a corresponding device for checking the coloration of preforms, in which the preforms are transported into a collecting container by a transport device. As they leave the transport device, the preforms are introduced randomly into the collecting container, wherein an image is taken by means of the image recording unit between leaving the transport device and the collecting container. The image is processed by a processing unit in such a way that the coloration of the preforms is checked, and preforms with a defective coloration are identified. In one embodiment of the known device, the preforms slide into the collecting container via a plate after leaving the transport device. The plate positions the preforms in one plane relative to the image recording unit without the need to use special alignment devices. In addition, the plate serves as a background in the recorded images, thus enabling optimum evaluation of the images. In particular, this plate has a color which has a good contrast with the color of the preforms.

The known device allows only optical checking of the coloration of preforms as these slide along the sloping plate between the transport unit and the collecting container.

It is the object of the invention to provide a compact device which can be easily integrated into the system environment of an injection molding machine and can selectively segregate individual, in particular defective, objects depending on the test result, which is not restricted to checking the coloration of preforms.

According to the invention, this object is achieved by means of a device having the features of claim 1. Advantageous refinements will become apparent from the features of the dependent claims.

The device according to the invention is used for optical checking of features of elongate, rotationally symmetrical objects, in particular preforms. The device is arranged in the product flow downstream of an injection molding machine and makes it possible to check and assess the vast majority of the objects produced by the injection molding machine in an unoriented object flow, and to remove defective objects.

As essential components, the device according to the invention comprises a sloping plate, ejection fingers arranged on the lower edge of the sloping plate and provided with drives, and a plurality of image recording units, in particular digital cameras, directed at the sloping plate. The abovementioned components can be integrated easily into the existing system environment of an injection molding machine by virtue of their compact dimensions.

The slope of the plate is determined in such a way that the objects move on the plate from the upper to the lower edge owing to the gravitational force acting on them. Depending on the slope and position of the objects, which are fed onto the plate at the upper edge as bulk material, these objects to be checked slide or roll over the surface of the plate in the direction of the lower edge of the plate.

The ejection fingers, which are arranged parallel to one another, side by side, and so as to be pivotable on the lower edge of the plate, can be pivoted out of a corresponding initial position into an ejection position. The separation between the ejection fingers arranged side-by-side is matched to the diameter of the objects to be checked. In the initial position, the preferably flat surfaces of all the ejection fingers enclose an angle of at least 180° with the surface of the sloping plate. The angle is preferably exactly 180°, therefore the surfaces of the ejection fingers form a continuation of the flat sloping plate in the initial position.

Each ejection finger has a separate drive in order to pivot the respective ejection finger between the initial position and the ejection position, wherein the angle enclosed between the surface of the sloping plate and the surface of the ejection finger in the ejection position is less than 180°.

The plurality of image recording units directed at the sloping plate, the viewing angles of which cover the plate at least over the entire width thereof, contribute to the small overall size of the device and simple integration into the system environment of the injection molding machine. Each of the plurality of image recording units synchronously records, at different points in time with a corresponding frequency, a plurality of digital images of the objects moving on the sloping plate. On account of the desire for the sloping plate to have a short length, it is necessary for the images to be recorded with a high frequency, e.g. in a range of from 50 Hz to 100 Hz, preferably with a frequency above 70 Hz. The short length of the sloping plate that is made possible by the high frequency contributes to a small loss of height in the transport flow of the objects to be checked and thus to a small space requirement of the device.

A processing unit, e.g. a personal computer or a distributed system, i.e. a data processing environment in which different components are distributed between several computers in a network, is programmed in such a way as to recognize all completely imaged objects in the digital images synchronously recorded at the different points in time, to check each recognized object for at least one feature by comparison with a reference object, to track each recognized object and to calculate at what point in time and in what rotational position each recognized object will reach a position in the region of the ejection fingers, wherein the drive of one or more ejection fingers is selectively actuated in accordance with this calculation and the result of the checking of the at least one feature in order to eject the recognized object.

The rotational position describes the orientation of the objects to be checked on the surface of the sloping plate and the ejection fingers, in particular by means of a rotation angle of a detected axis of the object with respect to an axis in a reference system. The detected axis can be the longitudinal axis of the preform, for example.

The calculation of the points in time at which a recognized and tracked object has reached a certain position is modeled. The modeling can be based, for example, on the movement model of the constant acceleration, starting from an assumed initial speed, of each object as it is transferred to the sloping plate. The assumed initial speed is based, for example, on the transport speed of a steady-flow conveyor which transfers the objects to be checked to the sloping plate at the upper edge. In modeling, the position detected in the images recorded at different points in time, the rotational position and the speed of the detected object determined at the recording time are taken into account. The recognition of corresponding objects in the recorded images is accomplished with the aid of an algorithm by comparison with a reference object of the objects to be checked. In the comparison, only those objects are used which are completely recognizable. If, for example, a number of objects are close together in the image and can therefore not be recognized completely, these objects are filtered out.

In order to feed in the objects present as bulk material, in particular preforms, as a single layer to the sloping plate, the device in one embodiment of the invention comprises a belt conveyor having a belt transfer location, which is arranged above the upper edge of the sloping plate in such a way that the objects to be checked are transferred from the belt conveyor to the sloping plate. The preforms are transported from the injection molding machine on the belt conveyor. The sloping plate preferably adjoins the belt transfer location at the end of the belt conveyor in such a way that, as far as possible, the preforms do not fall onto the plate but are transferred almost tangentially.

The sloping plate has a slope angle of from 30° to 40°, preferably 35°, to the horizontal. Given such a slope angle, the preforms, which are round in cross section, predominantly slide along the plate from the upper edge toward the lower edge. A shallower angle of less than 30° has the effect that preforms lying crosswise roll and, on account of the variation in the diameter of the preforms in the direction of the longitudinal axis, move either sharply in the direction of the left or right side of the sloping plate, depending on the rotational position, on the way from the upper to the lower edge of the sloping plate, making it more difficult to track the preforms in the images recorded at different points in time.

The transport speed of the preforms on the belt conveyor is preferably lower by a factor of 2 than the mean transport speed of each preform moving from the upper to the lower edge on the sloping plate. On the belt conveyor, the preforms are usually transported at a speed of 0.16 m/s to 0.5 m/s from the injection molding machine. The mean speed of the preforms on a plate with a slope angle of 35° is approximately 1-1.25 m/s.

This factor or these speed differences can be established by setting the conveyor belt speed and/or changing the slope angle of the plate, taking into account the geometry and weight of the preforms. The stated factor has the effect that the preforms to be checked are accelerated during the movement on the surface of the sloping plate, as a result of which the spacing between the preforms to be checked increases. Separating the preforms to be checked increases the number of preforms that can be completely recognized in the images recorded. In the images, few preforms or no preforms are now close together, and therefore the vast majority of the preforms captured in the images is recognized completely.

The ejection fingers that are not deflected from the initial position form an extension of the surface of the sloping plate via which preforms are guided to a conveyor belt arranged below the lower edge of the sloping plate, which carries away the preforms that have not been ejected. The preforms that have not been ejected slide over the outer end of the ejection fingers which have not been deflected and fall onto the conveyor belt.

At the point in time at which they reach a position in the region of the ejection fingers, the preforms recognized as defective are ejected by one or more of the ejection fingers, depending on the rotational position of the defective preform.

The device preferably comprises an interception hood extending at least over the width of the sloping plate, and a cross conveyor, wherein the interception hood and the cross conveyor are arranged in such a way relative to the ejection fingers that the ejected objects either reach the cross conveyor directly or reach the cross conveyor after deflection by the interception hood.

To avoid reflections on the preforms to be checked during the recording of the images with the image recording units, the sloping plate preferably consists of a transparent material, e.g. glass, wherein a backlighting means is arranged on a rear side of the transparent plate. The backlighting means is preferably configured to produce lighting flashes at a frequency which corresponds to the recording frequency of the image recording units, wherein the production of the lighting flashes is synchronized with the recording times of the image recording units. In principle, however, the backlighting means can also be embodied as a permanent lighting means.

In order to capture the preforms over the entire width of the sloping plate, a plurality of image recording units, e.g. three digital cameras, is arranged next to one another in a row. To ensure that a preform is always completely recognizable in at least one recorded image, irrespective of its rotational position, the fields of view of the plurality of image recording units overlap in the direction of the width of the sloping plate in such a way that the overlap is greater than the length of the preforms to be checked. The overlap ensures that even a preform lying transversely on the surface is always completely recognizable in the image. Guides on the sloping plate which separate the preforms in accordance with the respective fields of view of the image recording units are unnecessary as a result.

The provision of a relatively large number of image recording units contributes to the ability to adapt the width of the sloping plate to the width of the belt conveyor feeding in the preforms to be checked without having to increase the spacing between the image recording units and the sloping plate and thereby increase the overall height of the device. Since one and the same preform can be simultaneously detected and tracked in the region of overlap between two image recording units, this must be taken into account and corrected during the processing of the image data in order to avoid duplicate tracking of this preform.

In principle, however, it is also possible to combine the images recorded at one point in time by the plurality of cameras into an overall image. In order to avoid the greater computing times and computer capacities associated with this, the overlapping of the viewing angles of the plurality of cameras is advantageous.

In order to ensure a high speed of the ejection fingers addressed when ejecting defective preforms, each ejection finger in an advantageous refinement of the invention is embodied at the end as a lever which is flat on an upper side, is mounted so as to be rotatable about an axis of rotation and has an articulation, arranged on an underside, for an output member of the drive, wherein, starting from the axis of rotation, the articulation is arranged in the first half of the lever. The short distance between the axis of rotation and the articulation results in a large lever travel for a small movement of the output member.

The length of all the ejection fingers is matched to the length of the preforms to be checked in such a way that it corresponds to at least half the length of each preform to be checked. For successful ejection, it is sufficient to hit the center of the longitudinal axis of the preform in the second half of the ejection finger, starting from the axis of rotation, but, as a particular preference, at a distance of three quarters of the length of the ejection finger from the axis of rotation. If this preferred distance is not precisely complied with owing to inaccuracies, unfavorable rotational positions and decelerations, the tolerance provided helps to ensure that the preform is nevertheless successfully ejected.

In order to be able to use the device to reliably check and eject different types of preform with different dimensions and/or a different weight, the pivoting angle between the initial position and the ejection position of each ejection finger is adjustable.

Each drive for one of the ejection fingers preferably comprises a double-acting pneumatic cylinder and a controller, wherein the controller is configured in such a way that the piston with the piston rod can be extended with an unthrottled air pressure, and the activation time of the air pressure is adjustable. By way of the activation times of the valves for the release of the air pressure, it is possible to influence the travel of the pneumatic cylinders and thus the pivoting angle of each ejection finger. In all cases, the activation time chosen is so short that the piston with the piston rod of any pneumatic cylinder does not move into its outer end position so as to protect the pneumatic cylinder from damage. Unthrottled extension is necessary in order to impart the necessary momentum during ejection to preforms recognized as defective. However, the return stroke of the double-acting pneumatic cylinder can take place in a throttled manner.

The invention is explained in greater detail below with reference to the drawings. In the drawings:

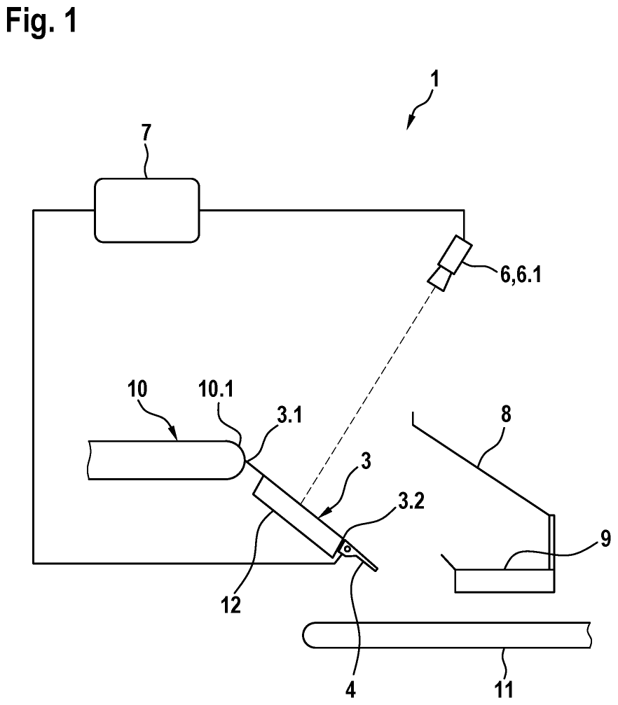

FIG. 1 shows a schematic illustration of a device according to the invention,

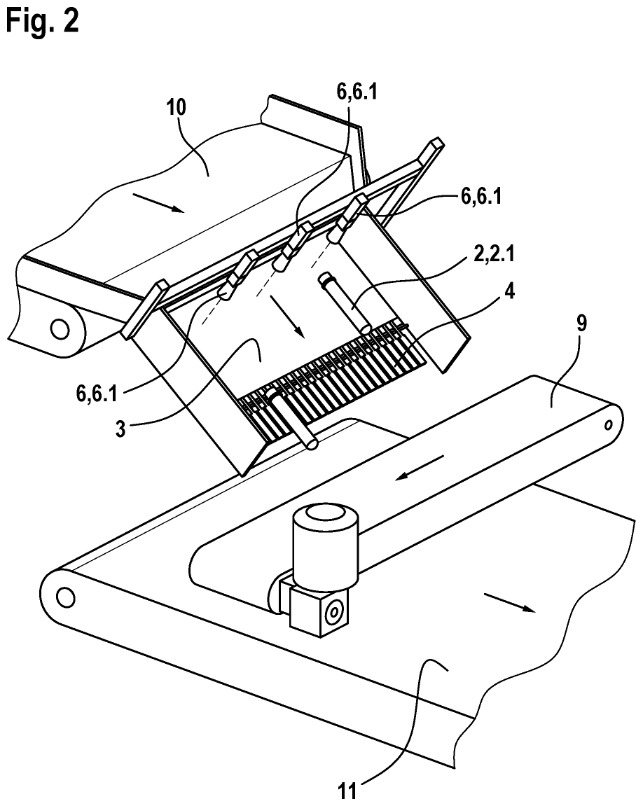

FIG. 2 shows a perspective partial view of a device according to the invention but without illustrating the interception hood,

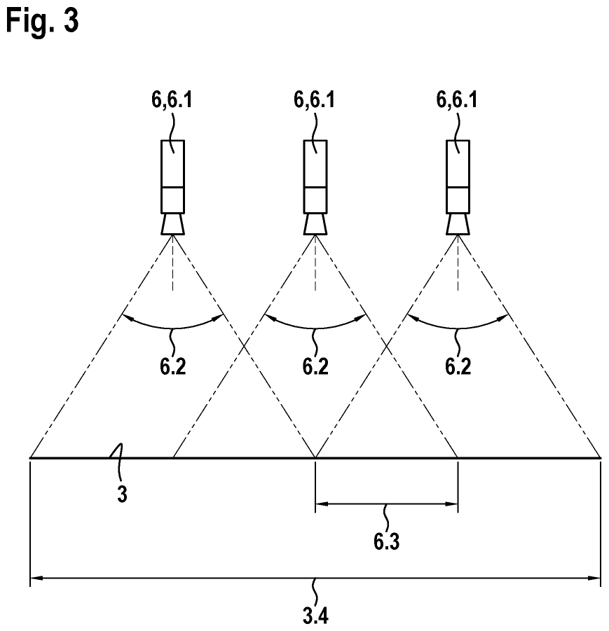

FIG. 3 shows a schematic illustration of the arrangement of a plurality of image recording units of a device according to the invention,

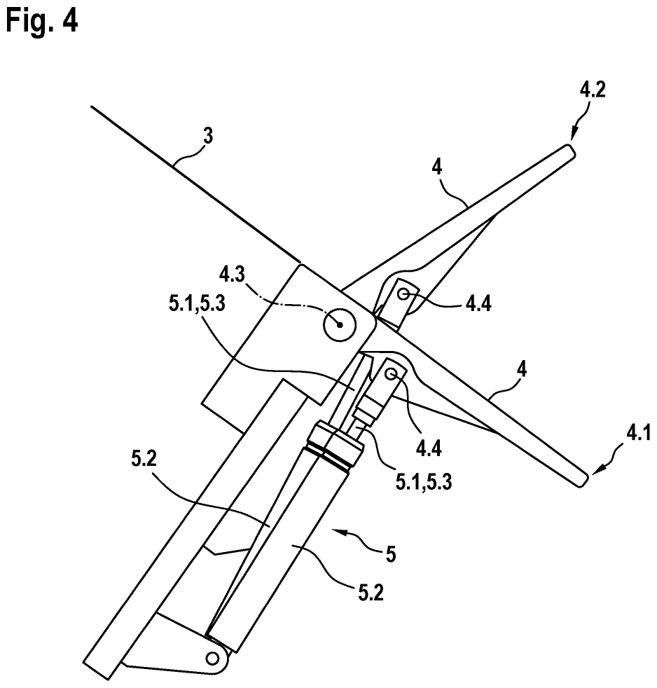

FIG. 4 shows a detail illustration of ejection fingers,

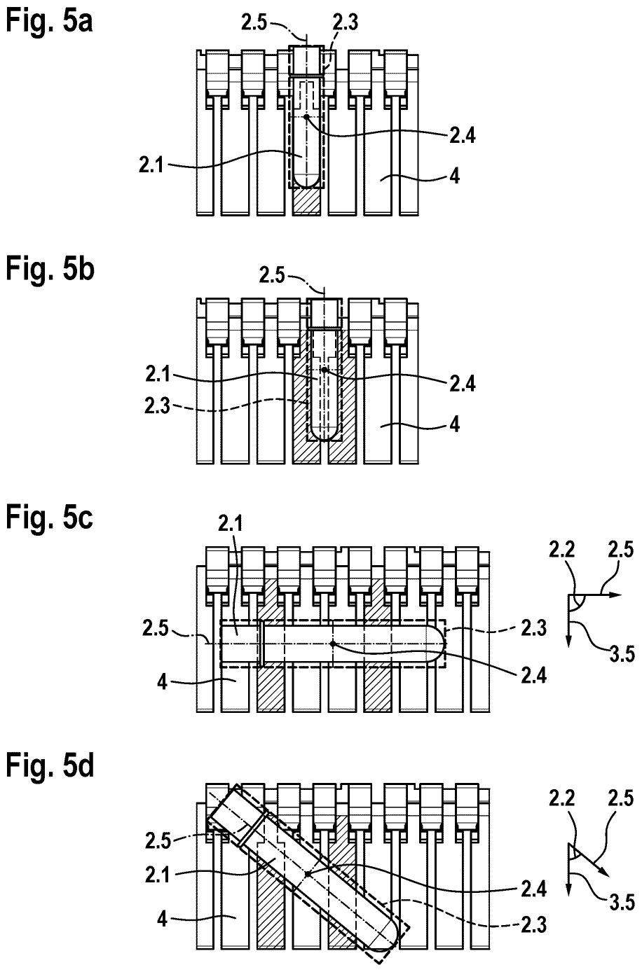

FIGS. 5a-d show plan views of some of the adjacently arranged ejection fingers of a device according to the invention.

FIG. 1 shows a device 1 according to the invention for optical checking of features of elongate, rotationally symmetrical objects 2, in particular preforms 2.1. As essential components, the device 1 comprises a sloping plate 3 with an upper and a lower edge 3.1, 3.2, the plate having a slope of 35° to the horizontal, with the result that the preforms 2.1 move, in particular slide, from the upper edge 3.1 to the lower edge 3.2 owing to the gravitational force acting on them.

A belt conveyor 10 conveys the preforms 2.1 from the injection molding machine (not illustrated in FIG. 1) to the sloping plate 3 of the device 1 according to the invention. The belt conveyor has a belt transfer location 10.1, which is arranged above the upper edge 3.1 of the sloping plate 3 and guides the preforms 2.1 to be checked in a single layer to the sloping plate 3.

The conveyor belt speed of the belt conveyor 10 is no more than half the mean transport speed of each preform 2.1 moving from the upper to the lower edge 3.1, 3.2 on the sloping plate 3, and therefore, when the preforms 2.1 are transferred from the belt conveyor 10 to the sloping plate 3, there is an increase in the spacing between the preforms due to the acceleration.

Ejection fingers 4 are arranged parallel to one another, side by side, on the lower edge 3.2 of the sloping plate 3 and can be pivoted out of a corresponding initial position 4.1 into an ejection position 4.2, as can be seen especially in FIG. 4. In the initial position 4.1, the flat surfaces of all the ejection fingers 4 enclose an angle of 180° with the flat surface of the sloping plate 3, and thus form a continuation of the sloping plate 3.

As can furthermore be seen from the detail illustration in FIG. 4, each ejection finger 4 has a separate drive 5 with an output member 5.1. In the exemplary embodiment illustrated, the drive 5 is a double-acting pneumatic cylinder 5.2 having a piston and an output-side piston rod 5.3.

Furthermore, the device 1 has a plurality of image recording units 6, which are directed at the sloping plate 3 and, in the exemplary embodiment illustrated, are embodied as digital cameras 6.1. As can be seen, in particular, from the perspective illustration in FIG. 2 in combination with the plan view in FIG. 3, the viewing angles 6.2 of the three digital cameras 6.1 arranged side-by-side cover the sloping plate 3 at least over the entire width 3.4 thereof. The digital cameras 6.1 are high-frequency cameras which each synchronously record three digital images of the preforms 2.1 moving on the plate at a corresponding frequency, in the exemplary embodiment of 72 Hz, at different points in time.

The viewing angles 6.2 of the three digital cameras 6.1 arranged side by side overlap in the direction of the width 3.4 of the sloping plate 3 in such a way that the overlap 6.3 is greater than the length of the respective preforms 2.1 to be checked. The overlap 6.3 has the effect that, irrespective of its rotational position 2.2, each preform 2.1 is always completely recognizable in at least one image recorded at one point in time by the plurality of digital cameras 6.1 (cf. FIG. 3).

In order to avoid reflections of the lighting on the preforms 2.1 to be checked during the recording of the images with the three digital cameras 6.1, the sloping plate 3 consists of glass and, on the rear side, has a backlighting means 12, which produces lighting flashes at a frequency which corresponds to the recording frequency of the three digital cameras 6.1. The production of the lighting flashes is synchronized with the recording times of the digital cameras 6.1.

A processing unit 7, which is illustrated schematically only in FIG. 1, is programmed in such a way as to recognize all completely imaged preforms 2.1 in the digital images synchronously recorded at different points in time, to check each recognized preform 2.1 for at least one feature, e.g. the dimensions and/or shape and/or color, by comparison with a reference object, wherein feature checking has to be performed only in one set of the images recorded by the digital cameras 6.1, to track each recognized preform 2.1 and to calculate at what point in time and in what rotational position each recognized preform 2.1 will reach a position in the region of the ejection fingers 4.

Depending on this calculation by the processing unit 7 and the result of checking the at least one feature, the pneumatic cylinder 5.2 of one or more of the ejection fingers 4 is actuated in order to eject the preform 2.1 recognized as defective in the context of feature checking.

An interception hood 8 (cf. FIG. 1) extends over the width of the sloping plate 3. Furthermore, there is a cross conveyor 9 below the interception hood 8 for carrying away the preforms 2.1 recognized as defective. The interception hood 8 and the cross conveyor 9 are arranged in such a way relative to the ejection fingers 4 that the ejected preforms 2.1 either reach the cross conveyor 9 directly or reach the cross conveyor 9 after deflection by the interception hood 9 and are transported away. The transport direction of the cross conveyor runs at right angles to the transport direction of the belt conveyor 10.

In order to ensure a high speed of the addressed ejection fingers 4 when ejecting defective preforms 2.1, each ejection finger 4 is, as can be seen in FIG. 4, supported at the end in such a way as to be rotatable about an axis of rotation 4.3, wherein an articulation 4.4 for the outer end of the piston rod 5.3 is arranged in the first half of the ejection finger 4. The short distance between the axis of rotation 4.3 and the articulation 4.4 results in a large lever travel for a relatively small movement of the piston rod 5.3. The ejection finger at the front in the plane of the drawing is in the initial position 4.1, while the ejection finger at the rear in the plane of the drawing is in the ejection position 4.2.

The activation of the ejection fingers 4 by pressurizing the pneumatic cylinders 5.2 is explained below with reference to the illustrations in FIGS. 5a-5d, taking into consideration different rotational positions 2.2 of the preforms 2.1 to be ejected.

In the illustrations, the preforms 2.1 that have been completely recognized in the image are framed by a box 2.3, which closely surrounds the preform 2.1. The central point 2.4 of the longitudinal axis 2.5 of the box 2.3 is considered as the geometric central point of the recognized preform 2.1. In the text which follows, for the sake of simplicity, the longitudinal axis 2.5 of the box 2.3 and the central point 2.4 of the longitudinal axis 2.5 are taken to be equivalent to the longitudinal axis and the central point of the recognized preform 2.1.

FIG. 5a shows a preform 2.1 recognized as defective, the longitudinal axis 2.5 of which runs parallel to the ejection fingers 4. The preform 2.1 is located above precisely one ejection finger 4, the pneumatic cylinder 5.2 of which is activated in order to eject the preform 2.1 recognized as defective. The ejection finger 4 is activated if the central point 2.4 of the longitudinal axis 2.5 is in the second half of the ejection finger 4, starting from the axis of rotation 4.3 thereof.

FIG. 5b shows a preform 2.1 recognized as defective, the longitudinal axis 2.5 of which runs parallel to the ejection fingers 4. The preform 2.1 is located above two ejection fingers 4, the pneumatic cylinders 5.2 of which are activated in order to eject the preform 2.1 recognized as defective. The two ejection fingers 4 are activated if the central point 2.4 of the longitudinal axis 2.5 is in the second half of the two ejection fingers 4, starting from the axes of rotation 4.3 thereof.

FIG. 5c shows a preform 2.1 recognized as defective with a rotational position 2.2, in which the longitudinal axis 2.5 is rotated by a rotation angle of 90° to a vertical axis 3.5 of a reference system. The preform 2.1 is located above seven ejection fingers 4. The longitudinal axis 2.5 is divided into four sections of equal length. The two points on the longitudinal axis 2.5 at ¼ and ¾ of the length of the box 2.3 trigger the activation of the ejection fingers closest to the two points.

FIG. 5d shows a preform 2.1 recognized as defective with a rotational position 2.2, in which the longitudinal axis 2.5 is rotated by a rotation angle of 45° to a vertical axis 3.5 of a reference system. The preform 2.1 is located above seven ejection fingers 4. The longitudinal axis 2.5 is divided into four sections of equal length. The two points on the longitudinal axis 2.5 at ¼ and ¾ of the length of the box 2.3 trigger the activation of the ejection fingers closest to the two points.

### LIST OF REFERENCE SIGNS

| | |
|---|---|
| 1 | device |
| 2 | objects |
| 2.1 | preforms |
| 2.2 | rotational position |
| 2.3 | box |
| 2.4 | central point |
| 2.5 | longitudinal axis |
| 3 | sloping plate |
| 3.1 | upper edge |
| 3.2 | lower edge |
| 3.3 | slope angle |
| 3.4 | width |
| 3.5 | vertical axis |
| 4 | ejection finger |
| 4.1 | initial position |
| 4.2 | ejection position |
| 4.3 | axis of rotation |
| 4.4 | articulation |
| 4.5 | pitch |
| 5 | drive |
| 5.1 | output member |
| 5.2 | pneumatic cylinder |
| 5.3 | piston rod |
| 6 | image recording unit |
| 6.1 | digital camera |
| 6.2 | viewing angle |
| 6.3 | overlap |
| 6.4 | holder |
| 7 | processing unit |
| 8 | interception hood |
| 9 | cross conveyor |
| 10 | belt conveyor (feed) |
| 10.1 | belt transfer location |
| 11 | belt conveyor (discharge) |
| 12 | backlighting means |

1.-13. (canceled)

14. A device for optically checking features of elongate, rotationally symmetrical objects that are preforms, comprising
an inclined plate with an upper edge and a lower edge, each of the upper edge and the lower edge extending across a width of the plate, wherein a slope of the inclined plate is arranged in such a way that the objects move on a surface of the inclined plate from the upper edge to the lower edge owing to the gravitational force acting on them;
ejection fingers disposed along the lower edge of the inclined plate and arranged parallel to one another, side by side, so as to be pivotable out of a corresponding initial position into an ejection position,
wherein, in the initial position, surfaces of each of the ejection fingers enclose an angle of at least 180° with the surface of the inclined plate;
each ejection finger of the ejection fingers includes a respective drive to pivot the each ejection finger of the ejection fingers between the initial position and the ejection position, wherein the angle enclosed between the surface of the inclined plate and the surface of the ejection fingers in the ejection position is less than 180°;
a plurality of image recording units directed at the inclined plate, wherein the viewing angles of the plurality of image recording units cover the inclined plate at least over the entire width thereof, and each of the plurality of image recording units is configured to synchronously record, at different points in time with a corresponding recording frequency in a range from 50 Hz to 100 Hz, a plurality of digital images of the objects moving on the inclined plate; and
a processing unit programmed to recognize all completely imaged objects in the digital images synchronously recorded at the different points in time, to check at least on feature of each recognized object by comparison with a reference object, to track a movement of each recognized object, and to perform a calculation, for the each recognized object, of a point in time and a rotational position when the each recognized object will reach a position in the region of the ejection fingers, wherein the drive of one or more of the ejection fingers is selectively actuated in accordance with this calculation and the result of the checking of the at least one feature to eject the recognized object.

15. The device as claimed in claim 14, further comprising a belt conveyor with a belt transfer location arranged above the upper edge of the inclined plate, wherein the objects are transferred from the belt conveyor to the inclined plate at the belt transfer location.

16. The device as claimed in claim 15, wherein a speed of the belt conveyor is set so that the transport speed of the objects on the belt conveyor is lower by a factor of at least 2 than a mean transport speed of each object moving from the upper edge to the lower edge on the inclined plate.

17. The device as claimed in claim 14, further comprising an output belt conveyor configured to carry away the objects which have not been ejected, the output belt conveyor being arranged below the lower edge of the inclined plate.

18. The device as claimed in claim 14, further comprising an interception hood extending at least over the width of the inclined plate, and a cross conveyor, wherein the interception hood and the cross conveyor are arranged relative to the ejection fingers so that ejected objects either reach the cross conveyor directly or reach the cross conveyor after deflection by the interception hood.

19. The device as claimed in claim 14, wherein an angle of the slope of the inclined plate is between 30° and 40° to the horizontal.

20. The device as claimed in claim 14, wherein the inclined plate consists of a transparent material, and a backlighting means is arranged on a rear side of the inclined plate.

21. The device as claimed in claim 20, wherein the backlighting means is configured to produce lighting flashes at a frequency which corresponds to the recording frequency of the image recording units, and the production of the lighting flashes is synchronized with recording times of the image recording units.

22. The device as claimed in claim 14, wherein the viewing angles of the plurality of image recording units overlap in the direction of the width of the inclined plate in such a way that the overlap is greater than the length of the objects to be checked.

23. The device as claimed in claim 14, wherein the each ejection finger is embodied at the end as a lever which is flat on an upper side and is pivotable about an axis of rotation, and has an articulation arranged on an underside for an output member of the drive, wherein, starting from the axis of rotation, the articulation is arranged in a first half of the lever.

24. The device as claimed in claim 23, wherein a length of each lever corresponds to at least half a length of each object of the objects to be checked.

25. The device as claimed in claim 14, wherein a pivoting angle between the initial position and the ejection position of the each ejection finger is adjustable.

26. The device as claimed in claim 14, wherein the drive for the each ejection finger comprises a double-acting pneumatic cylinder having a piston and a piston rod and a controller, wherein the controller is configured in such a way that the piston with the piston rod can be extended with an unthrottled air pressure, and the activation time of the air pressure is adjustable.
